(19) United States
(12) Patent Application Publication
(10) Pub. No.: US 2019/0166265 A1
(43) Pub. Date: May 30, 2019

(54) IMAGE PROCESSING DEVICE

(71) Applicant: KYOCERA Document Solutions Inc., Osaka (JP)

(72) Inventor: Yasushi SAITO, Osaka-shi (JP)

(73) Assignee: KYOCERA Document Solutions Inc., Osaka (JP)

(21) Appl. No.: 16/203,218

(22) Filed: Nov. 28, 2018

(30) Foreign Application Priority Data
Nov. 30, 2017 (JP) 2017-229943

(51) Int. Cl. H04N 1/00; G06K 9/46; G06K 9/00

(52) U.S. Cl. CPC H04N 1/00331; G06K 9/00456; H04N 1/00167; G06K 9/46

(57) ABSTRACT

An image processing device includes an image reading section, a line image detection section, an overlapping part detection section, and an image processing section. The image reading section acquires a read image by reading an image from a document. The line image detection section detects a plurality of line images included in the read image. The plurality of line images includes a first line image and a second line image. The overlapping part detection section detects an overlapping part where the first line image and the second line image overlap each other. The image processing section performs image processing on the overlapping part.

### INCORPORATION BY REFERENCE

The present application claims priority under 35 U.S.C. § 119 to Japanese Patent Application No. 2017-229943, filed on Nov. 30, 2017. The contents of this application are incorporated herein by reference in their entirety.

### BACKGROUND

The present disclosure relates to an image processing device.

An image processing device distinguishes a character region and an illustration region of an input image. The image processing device italicizes characters included in the character region to visually distinguish the character region from the illustration region.

### SUMMARY

An image processing device according to the present disclosure includes an image reading section, a line image detection section, an overlapping part detection section, and an image processing section. The image reading section acquires a read image by reading an image from a document. The line image detection section detects a plurality of line images included in the read image. The plurality of line images includes a first line image and a second line image. The overlapping part detection section detects an overlapping part where the first line image and the second line image overlap each other. The image processing section performs image processing on the overlapping part.

### BRIEF DESCRIPTION OF THE DRAWINGS

FIG. 1 is a block diagram of an image forming apparatus according to an embodiment of the present disclosure.

FIGS. 2A and 2B are schematic diagrams illustrating a document.

FIGS. 3A to 3C are schematic diagrams each illustrating a read image subjected to image processing.

FIG. 4 is a flowchart illustrating an image processing method performed by an image processing device according to the embodiment of the present disclosure.

FIGS. 5A and 5B are schematic diagrams each illustrating a read image subjected to image processing.

FIG. 6 is a flowchart illustrating an image processing method performed by the image processing device according to the embodiment of the present disclosure.

FIG. 7 is a schematic diagram illustrating a read image subjected to image processing.

FIG. 8 is a flowchart illustrating an image processing method performed by the image processing device according to the embodiment of the present disclosure.

FIG. 9 is a flowchart illustrating an image processing method performed by the image processing device according to the embodiment of the present disclosure.

FIGS. 10A and 10B are schematic diagrams illustrating a document. FIGS. 10C and 10D are schematic diagrams each illustrating a read image subjected to image processing.

FIGS. 11A and 11B are schematic diagrams illustrating a document.

FIGS. 12A to 12C are schematic diagrams each illustrating a read image subjected to image processing.

FIGS. 13A and 13B are schematic diagrams each illustrating a read image subjected to image processing.

FIG. 14 is a schematic diagram illustrating a read image subjected to image processing.

### DETAILED DESCRIPTION

The following describes an embodiment of the present disclosure with reference to the accompanying drawings. Note that elements that are the same or equivalent are labelled using the same reference signs in the drawings, and description of those elements will not be repeated.

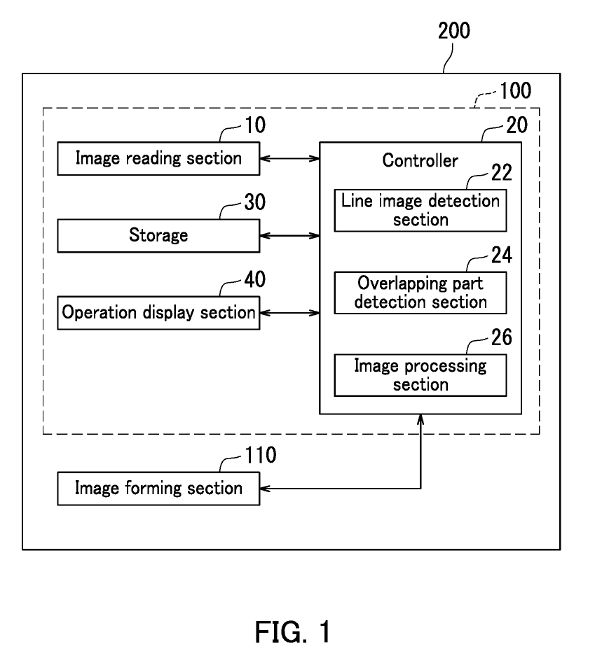

The following describes an image forming apparatus 200 according to the embodiment of the present disclosure with reference to FIG. 1. FIG. 1 is a block diagram of the image forming apparatus 200 according to the embodiment of the present disclosure.

As illustrated in FIG. 1, the image forming apparatus 200 includes an image processing device 100 and an image forming section 110. The image forming apparatus 200 may be a copier, a printer, or a facsimile machine. Alternatively, the image forming apparatus 200 may be a multifunction peripheral having functions of at least two of the copier, the printer, and the facsimile machine. The image forming apparatus 200 may be a color multifunction peripheral or a monochrome multifunction peripheral.

The image processing device 100 performs image processing. The image processing device 100 is for example installed in the image forming apparatus 200. The image processing device 100 includes an image reading section 10, a controller 20, storage 30, and an operation display section 40.

The image reading section 10 acquires a read image by reading an image from a document.

The controller 20 includes a line image detection section 22, an overlapping part detection section 24, and an image processing section 26. The controller 20 is a central processing unit (CPU), for example.

The line image detection section 22 detects a plurality of line images included in the read image. Each line image is an image representing a line having a constant width, for example. The line image represents a straight line or a curved line, for example. The plurality of line images includes a first line image and a second line image.

The overlapping part detection section 24 detects an overlapping part. The overlapping part is a part where the first line image and the second line image overlap each other.

The image processing section 26 performs image processing on the overlapping part.

The storage 30 includes a read only memory (ROM) device and a random access memory (RAM) device, for example. The ROM device stores a control program therein.

The operation display section 40 is a touch panel, for example. The operation display section 40 is used by a user to operate the image processing device 100.

The image forming section 110 forms an image subjected to image processing by the image processing device 100 on a recording medium.

The image processing section 26 of the image processing device 100 performs image processing on the overlapping part where the line images overlap each other. Therefore, the line images can be prevented from losing continuity in the part where the line images overlap each other.

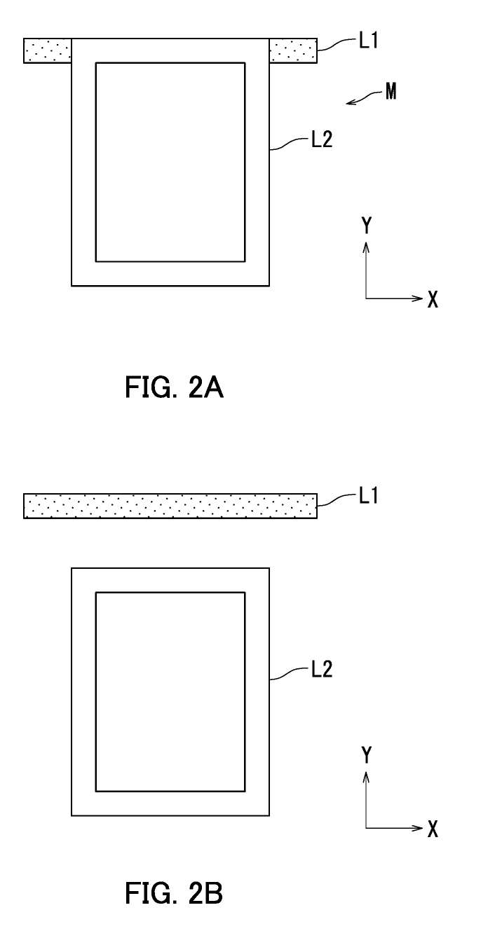

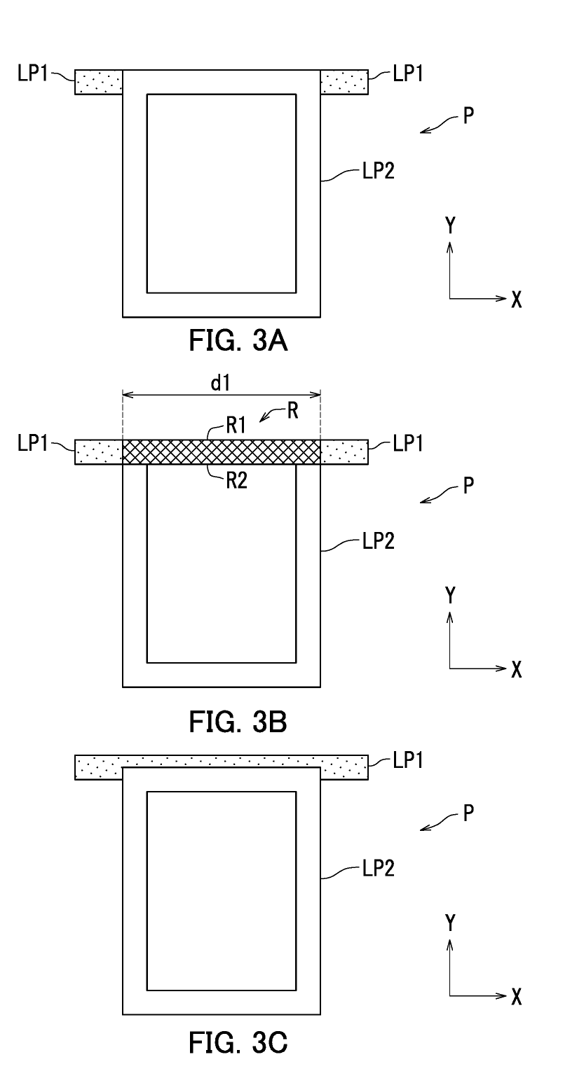

The following describes an image processing method performed by the image processing device 100 according to the embodiment of the present disclosure with reference to FIGS. 1 to 3C. FIGS. 2A and 2B are schematic diagrams illustrating a document M. FIGS. 3A to 3C are schematic diagrams each illustrating a read image P subjected to image processing. In FIG. 3B, d1 indicates a length of an overlapping part R along an X axis.

As illustrated in FIG. 2A, a first line image L1 and a second line image L2 are formed on the document M. Specifically, the document M has an image formed thereon in which the first line image L1 and the second line image L2 illustrated in FIG. 2B overlap each other. The first line image L1 has the shape of a straight line extending along the X axis. The second line image L2 has the shape of a hollow rectangle. Since the second line image L2 overlaps the first line image L1, part of the first line image L1 cannot be seen as illustrated in FIG. 2A. That is, the first line image L1 formed on the document M is interrupted. Therefore, it cannot be confirmed by seeing the document M whether or not the first line image L1 is continuous though it can be confirmed that the second line image L2 is continuous.

In a situation in which the first line image L1 is interrupted as illustrated in FIG. 2A, the image processing device 100 performs image processing to maintain continuity of the first line image L1.

The image reading section 10 acquires the read image P as illustrated in FIG. 3A by reading the image from the document M. The line image detection section 22 then detects a plurality of line images included in the read image P. In the present embodiment, the line image detection section 22 detects a first line image LP1 and a second line image LP2 included in the read image P. The first line image LP1 corresponds to the first line image L1 formed on the document M. The second line image LP2 corresponds to the second line image L2 formed on the document M. The first line image LP1 and the second line image LP2 each have a constant width.

The first line image LP1 has a first color. The second line image LP2 has a second color. The first color and the second color differ from each other. The first color is blue, for example. The second color is red, for example.

The overlapping part detection section 24 detects an overlapping part R as illustrated in FIG. 3B. The overlapping part detection section 24 detects, as the overlapping part R, an image region located between two line image segments of the same color, for example. In the present embodiment, the overlapping part detection section 24 detects, as the overlapping part R, an image region located between a left line image segment and a right line image segment of the first line image LP1. The first line image LP1 and the second line image LP2 are parallel to each other in the overlapping part R.

The image processing section 26 divides the overlapping part R into a first region R1 and a second region R2. In the present embodiment, the image processing section 26 sets an upper half region of the overlapping part R as the first region R1 and sets a lower half region of the overlapping part R as the second region R2. The first region R1 and the second region R2 are equal in size in the present embodiment. Note that the first region R1 and the second region R2 may differ from each other in size.

The image processing section 26 performs image processing by setting the color of the first region R1 to the first color and setting the color of the second region R2 to the second color as illustrated in FIG. 3C. In the present embodiment, the image processing section 26 sets the color of the upper half region (R1) of the overlapping part R to blue in the image processing. Also, the image processing section 26 sets the color of the lower half region (R2) of the overlapping part R to red in the image processing. In this configuration, continuity of each of the first line image LP1 and the second line image LP2 can be visually recognized. Therefore, it is possible to prevent the line images from losing continuity in the part where the line images overlap each other.

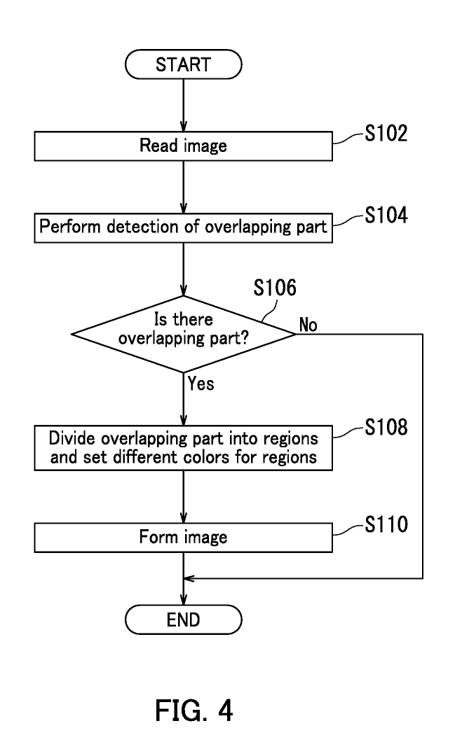

The following further describes the image processing method performed by the image processing device 100 according to the embodiment of the present disclosure with reference to FIGS. 1 to 4. FIG. 4 is a flowchart illustrating the image processing method performed by the image processing device 100 according to the embodiment of the present disclosure. Through execution of processing from Step S102 to Step S110 illustrated in FIG. 4, image processing is performed on the read image P acquired by reading the document M.

At Step S102, the image reading section 10 reads an image from the document M. Specifically, the image reading section 10 acquires the read image P by reading the image from the document M. The routine then proceeds to Step S104.

At Step S104, the overlapping part detection section 24 performs detection of an overlapping part R. The routine then proceeds to Step S106.

At Step S106, the image processing section 26 determines whether or not there is an overlapping part R. When the image processing section 26 determines that there is no overlapping part R (Step S106: No), the processing ends. When the image processing section 26 determines that there is an overlapping part R (Step S106: Yes), the routine proceeds to Step S108.

At Step S108, the overlapping part R is divided into regions and different colors are set for the respective regions. Specifically, the image processing section 26 divides the overlapping part R into the first region R1 and the second region R2. The image processing section 26 then performs image processing by setting the color of the first region R1 to the first color and setting the color of the second region R2 to the second color. The routine then proceeds to Step S110.

At Step S110, the image forming section 110 forms an image subjected to the image processing by the image processing device 100 on a recording medium. The processing ends then.

As described above with reference to FIGS. 1 to 4, the image processing section 26 of the image processing device 100 performs the image processing on the overlapping part R where the line images overlap each other. Therefore, it is possible to prevent the line images from losing continuity in the part where the line images overlap each other.

Also, the image processing section 26 divides the overlapping part R into the first region R1 and the second region R2. The image processing section 26 then performs the image processing by setting the color of the first region R1 to the first color and setting the color of the second region R2 to the second color. Thus, the respective regions of the part where the line images overlap are distinguished from each other in color. In this configuration, it is possible to prevent the line images from losing continuity in the part where the line images overlap each other.

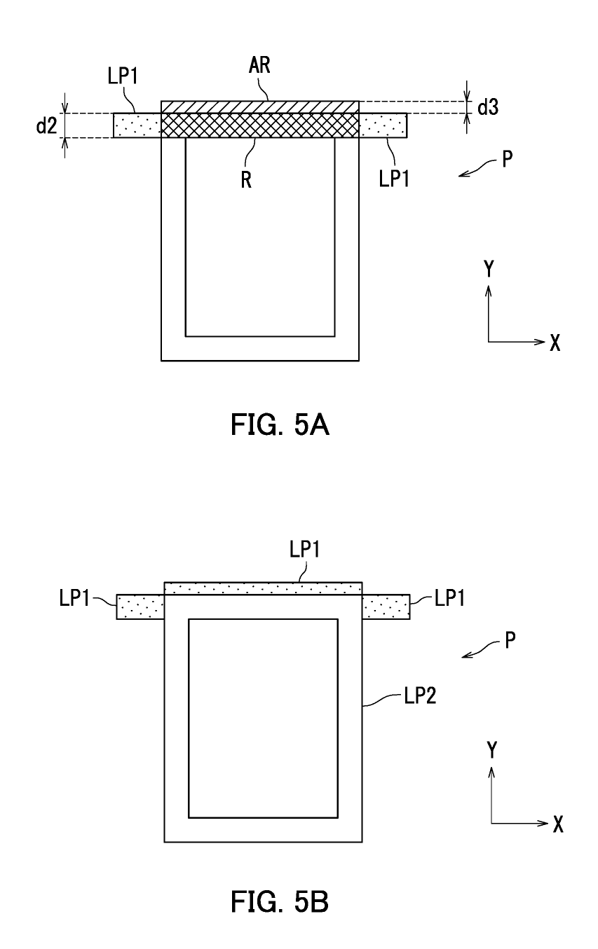

The following describes another image processing method performed by the image processing device 100 according to the embodiment of the present disclosure with reference to FIGS. 1, 2A, 2B, 5A, and 5B. FIGS. 5A and 5B are schematic diagrams each illustrating a read image P subjected to image processing. In FIG. 5A, d2 indicates a width of the overlapping part R (a length thereof along a Y axis). Also, d3 indicates a width of an adjacent region AR (a length thereof along the Y axis). The following image processing method differs from that described with reference to FIGS. 1 to 4 in contents of the image processing performed on the overlapping part R. Overlapping description of matter similar to that in the image processing method described with reference to FIGS. 1 to 4 will be omitted.

As illustrated in FIG. 5A, the image processing section 26 defines the adjacent region AR adjacent to the overlapping part R. The adjacent region AR extends along the overlapping part R.

As illustrated in FIG. 5B, the image processing section 26 performs the image processing by setting the color of the overlapping part R to one of the first color and the second color and setting the color of the adjacent region AR to the other of the first color and the second color. In the present embodiment, the image processing section 26 sets the color of the overlapping part R to red. Also, the image processing section 26 sets the color of the adjacent region AR to blue. In this configuration, continuity of each of the first line image LP1 and the second line image LP2 can be visually recognized. Therefore, it is possible to prevent the line images from losing continuity in the part where the line images overlap each other.

The image processing section 26 may determine the size of the adjacent region AR on the basis of a difference in hue between the first color and the second color. That is, the size of the adjacent region AR may be determined according to whether or not the first color of the first line image LP1 and the second color of the second line image LP2 are close to each other. For example, when the first color of the first line image LP1 and the second color of the second line image LP2 are close to each other, that is, when a difference in hue between the first color and the second color is small, the adjacent region AR is made large. By contrast, when the first color of the first line image LP1 and the second color of the second line image LP2 are far from each other, that is, when a difference in hue between the first color and the second color is large, the adjacent region AR is made small. Therefore, when the first color of the first line image LP1 and the second color of the second line image LP2 are close to each other, either the first color or the second color is assigned to a region extending far from the overlapping part R in the image processing. In this configuration, even when the first color of the first line image LP1 and the second color of the second line image LP2 are close to each other, it is possible to prevent the line images from losing visual continuity in the part where the line images overlap each other.

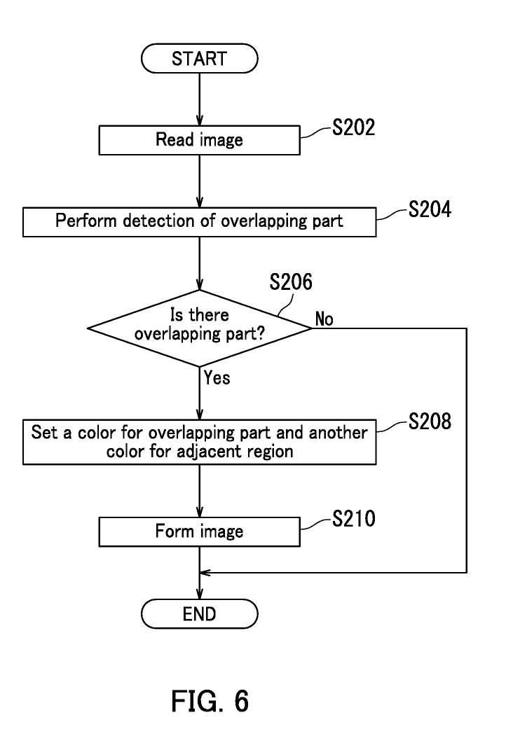

The following further describes the image processing method performed by the image processing device 100 according to the embodiment of the present disclosure with reference to FIGS. 1, 2A, 2B, 5A, 5B, and 6. FIG. 6 is a flowchart illustrating the image processing method performed by the image processing device 100 according to the embodiment of the present disclosure. Through execution of processing from Step S202 to Step S210 illustrated in FIG. 6, image processing is performed on the read image P. The image processing method illustrated by the flowchart of FIG. 6 is similar to that illustrated by the flowchart of FIG. 4 in all aspects other than that Step S208 differs from Step S108. Therefore, overlapping description will be omitted.

At Step S208, the image processing section 26 performs the image processing by setting the color of the overlapping part R to one of the first color and the second color and setting the color of the adjacent region AR to the other of the first color and the second color. The routine then proceeds to Step S210.

As described above with reference to FIGS. 1, 2A, 2B, 5A, 5B, and 6, the image processing is performed by setting the color of the overlapping part R to one of the first color and the second color and setting the color of the adjacent region AR to the other of the first color and the second color. In this configuration, continuity of each of the first line image LP1 and the second line image LP2 can be visually recognized. Therefore, it is possible to prevent the line images from losing continuity in the part where the line images overlap each other.

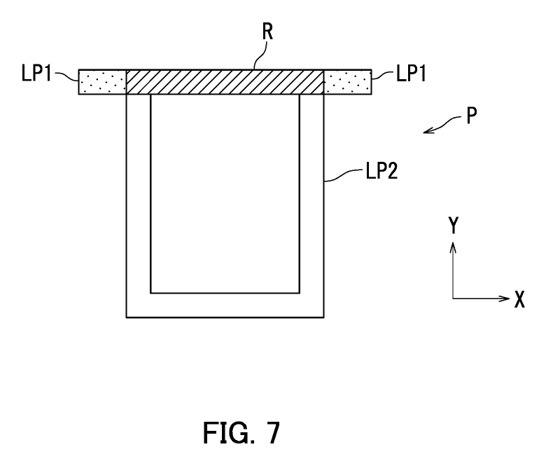

The following describes another image processing method performed by the image processing device 100 according to the embodiment of the present disclosure with reference to FIGS. 1, 2A, 2B, and 7. FIG. 7 is a schematic diagram illustrating a read image P subjected to image processing. The following image processing method differs from those described with reference to FIGS. 1 to 6 in contents of the image processing performed on the overlapping part R. Overlapping description of matter similar to that in the image processing methods described with reference to FIGS. 1 to 6 will be omitted.

In a situation in which there is an overlapping part R, the image processing section 26 performs image processing by setting the color of the overlapping part R to a third color as illustrated in FIG. 7. The third color differs from the first color and the second color. Preferably, the third color is a mixed color of the first color and the second color. In the image processing, the image processing section 26 sets the color of the overlapping part R to the third color, which is orange in the present embodiment. Orange is a mixed color of blue, which is the first color, and red, which is the second color.

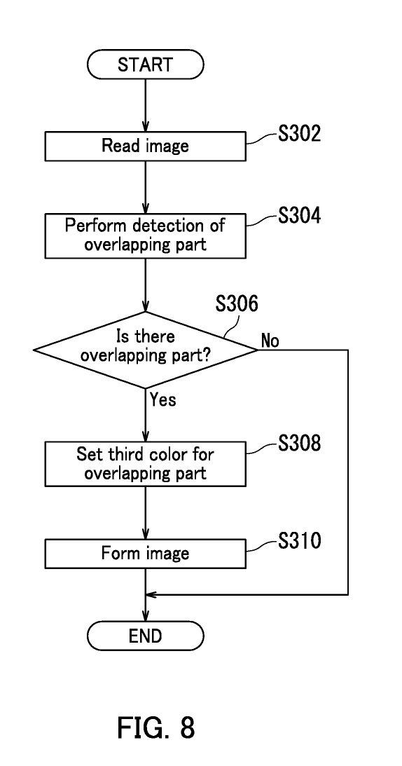

The following further describes the image processing method performed by the image processing device 100 according to the embodiment of the present disclosure with reference to FIGS. 1, 2A, 2B, 7, and 8. FIG. 8 is a flowchart illustrating the image processing method performed by the image processing device 100 according to the embodiment of the present disclosure. Through execution of processing from Step S302 to Step S310 illustrated in FIG. 8, image processing is performed on the read image P acquired by reading the document M. The image processing method illustrated by the flowchart of FIG. 8 is similar to that illustrated by the flowchart of FIG. 4 in all aspects other than that Step S308 differs from Step S108. Therefore, overlapping description will be omitted.

At Step S308, the image processing section 26 performs the image processing by setting the color of the overlapping part R to the third color. The routine then proceeds to Step S310.

As described above with reference to FIGS. 1, 2A, 2B, 7, and 8, the image processing section 26 performs the image processing by setting the color of the overlapping part R to the third color. In this configuration, it is possible to visually recognize that the first line image LP1 and the second line image LP2 overlap each other in the overlapping part R. Therefore, it is possible to prevent the line images from losing continuity in the part where the line images overlap each other.

Preferably, the third color is a mixed color of the first color and the second color. In this configuration, it is possible to visually confirm that the first line image LP1 in the first color and the second line image LP2 in the second color overlap each other in the overlapping part R.

The image processing section 26 may change contents of image processing according to the length of the overlapping part R.

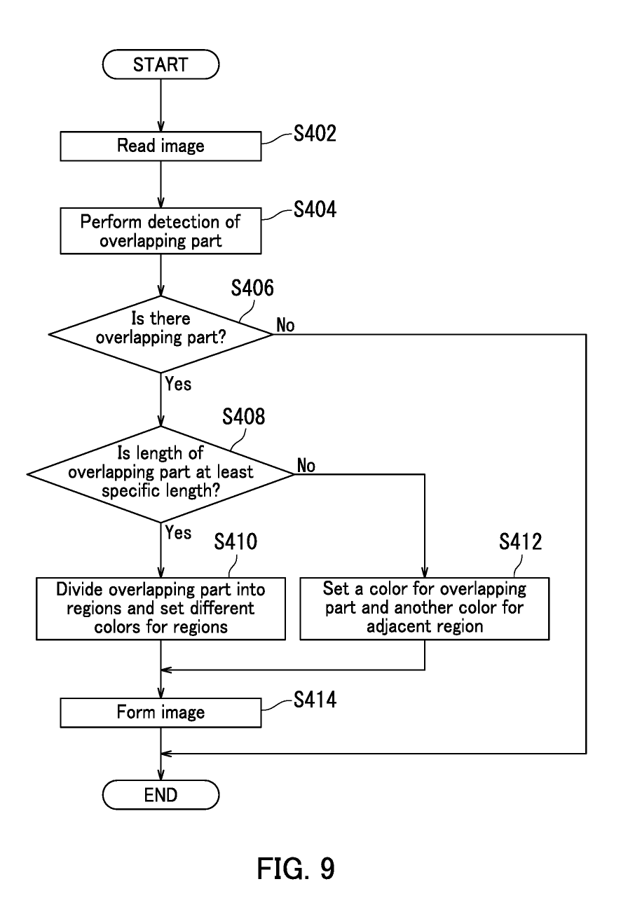

The following describes another image processing method performed by the image processing device 100 according to the embodiment of the present disclosure with reference to FIGS. 1, 2A, 2B, 3A to 3C, 7, and 9. FIG. 9 is a flowchart illustrating the image processing method performed by the image processing device 100 according to the embodiment of the present disclosure. Through execution of processing from Step S402 to Step S414 illustrated in FIG. 9, the image processing is performed on the read image P. The image processing method illustrated by the flowchart of FIG. 9 is similar to those illustrated by the flowcharts of FIGS. 4 and 6 in all aspects other than that contents of the image processing are changed according to the length of the overlapping part R. Therefore, overlapping description will be omitted.

At Step S402, the image reading section 10 reads an image from the document M. Specifically, the image reading section 10 acquires the read image P by reading the image from the document M. The routine then proceeds to Step S404.

At Step S404, the overlapping part detection section 24 performs detection of an overlapping part R. The routine then proceeds to Step S406.

At Step S406, the image processing section 26 determines whether or not there is an overlapping part R. When the image processing section 26 determines that there is no overlapping part R (Step S406: No), the processing ends. When the image processing section 26 determines that there is an overlapping part R (Step S406: Yes), the routine proceeds to Step S408.

At Step S408, the image processing section 26 determines whether or not the length d1 (see FIG. 3B) of the overlapping part R is at least a specific length. When it is determined that the length d1 of the overlapping part R is shorter than the specific length (Step S408: No), the routine proceeds to Step S412. When it is determined that the length d1 of the overlapping part R is at least the specific length (Step S408: Yes), the routine proceeds to Step S410.

At Step S410, the overlapping part R is divided into regions and different colors are set for the respective regions. Specifically, the image processing section 26 divides the overlapping part R into the first region R1 and the second region R2. The image processing section 26 then performs image processing by setting the color of the first region R1 to the first color and setting the color of the second region R2 to the second color. The routine then proceeds to Step S414.

At Step S412, the image processing section 26 performs image processing by setting the color of the overlapping part R to one of the first color and the second color and setting the color of the adjacent region AR to the other of the first color and the second color. The routine then proceeds to Step S414.

At Step S414, the image forming section 110 forms an image subjected to the image processing by the image processing device 100 on a recording medium. The processing ends then.

As described above with reference to FIGS. 1, 2A, 2B, 3A to 3C, 7, and 9, the image processing section 26 changes contents of the image processing according to the length d1 of the overlapping part R. In this configuration, it is possible to prevent the line images from losing continuity in the part where the line images overlap each other.

Although the first line image LP1 and the second line image LP2 are equal in width in the image processing methods described with reference to FIGS. 1 to 9, the first line image LP1 and the second line image LP2 may differ from each other in width.

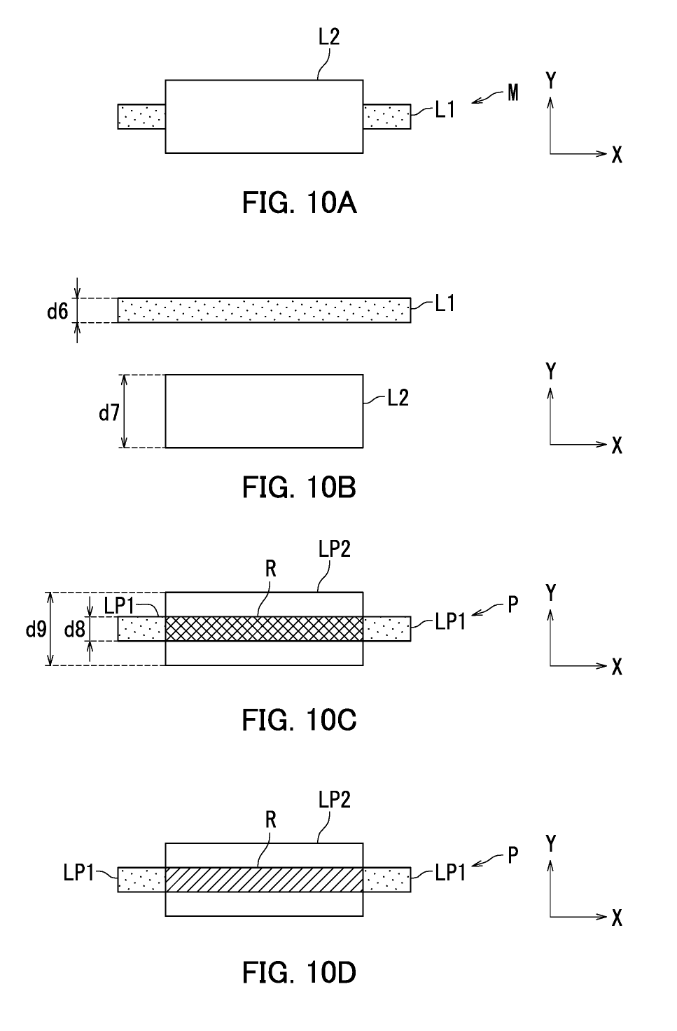

The following describes another image processing method performed by the image processing device 100 according to the embodiment of the present disclosure with reference to FIGS. 1 and 10A to 10D. FIGS. 10A and 10B are schematic diagrams illustrating a document M. FIGS. 10C and 10D are schematic diagrams each illustrating a read image P subjected to image processing. In FIG. 10B, d6 indicates a width of the first line image L1. Also, d7 indicates a width of the second line image L2. In FIG. 10C, d8 indicates a width of the first line image LP1. Also, d9 indicates a width of the second line image LP2. The following image processing method differs from those described with reference to FIGS. 1 to 9 in that the first line image LP1 and the second line image LP2 differ from each other in width. Overlapping description of matter similar to that in the image processing methods described with reference to FIGS. 1 to 9 will be omitted.

FIG. 10A illustrates a document M. The first line image L1 and the second line image L2 are formed on the document M. Specifically, the document M has an image formed thereon in which the first line image L1 and the second line image L2 illustrated in FIG. 10B overlap each other. The first line image L1 and the second line image L2 each have the shape of a straight line extending along the X axis. The width d7 of the second line image L2 is larger than the width d6 of the first line image L1.

The overlapping part detection section 24 detects an overlapping part R as illustrated in FIG. 10C. The width d9 of the second line image LP2 is larger than the width d8 of the first line image LP1.

The image processing section 26 performs image processing by setting the color of the overlapping part R to the third color as illustrated in FIG. 10D. The third color differs from the first color and the second color. Preferably, the third color is a mixed color of the first color and the second color. In the image processing, the image processing section 26 sets the color of the overlapping part R to the third color, which is orange in the present embodiment. Orange is a mixed color of blue, which is the first color, and red, which is the second color.

Although image processing is performed on the basis of the respective colors of the first line image L1 and the second line image L2 in the image processing methods described with reference to FIGS. 1 to 10D, image processing may be performed on the basis of respective line types of the first line image L1 and the second line image L2.

The term “line type” refers to a type of a line represented by a line image. Examples of line types include solid line, dash line, dash-dot line, and dash-dot-dot line.

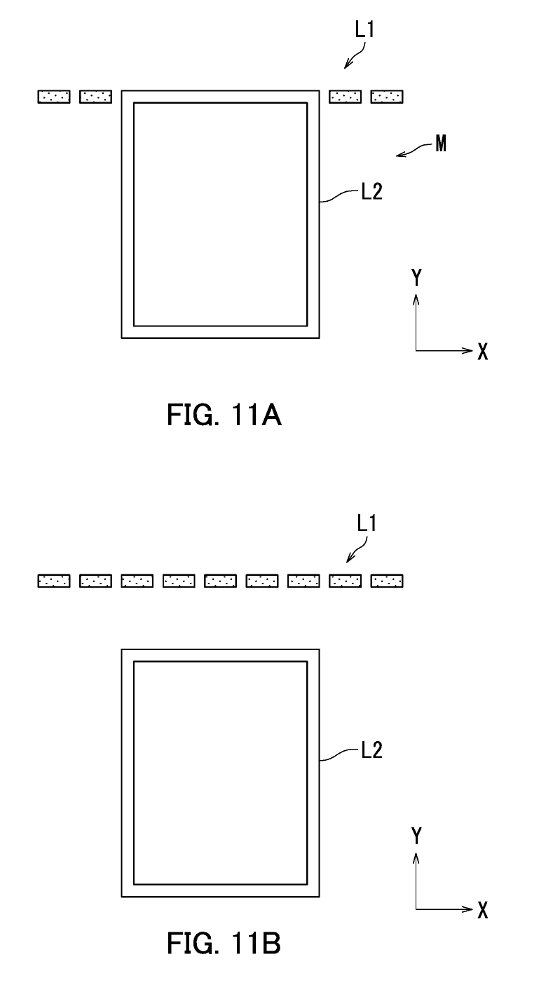

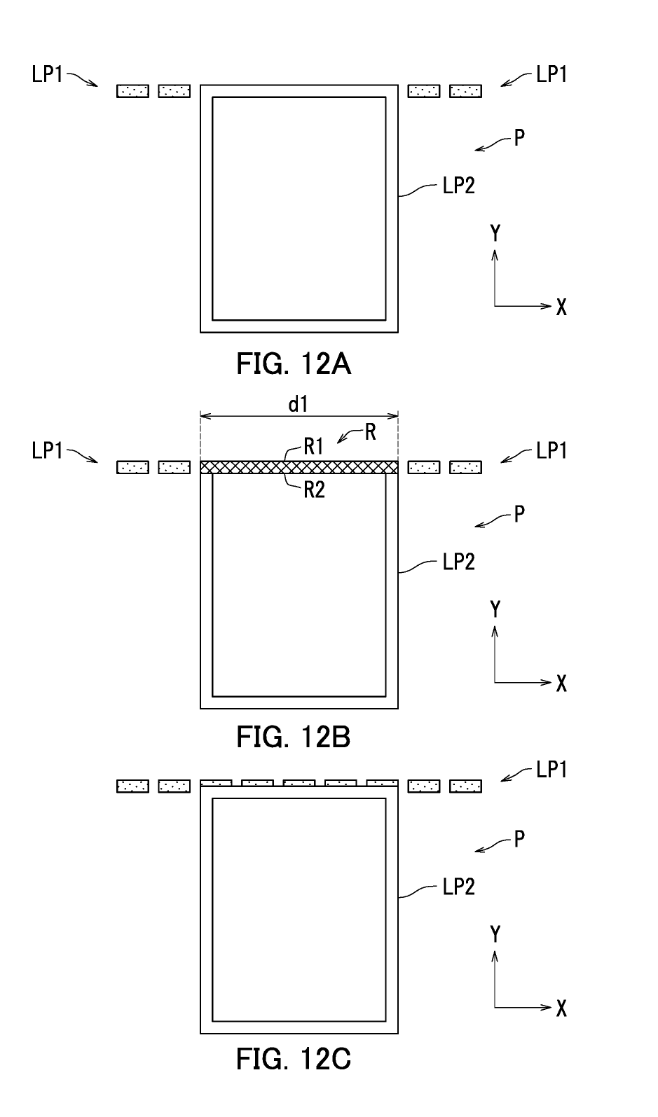

The following describes another image processing method performed by the image processing device 100 according to the embodiment of the present disclosure with reference to FIGS. 1 and 11A to 12C. FIGS. 11A and 11B are schematic diagrams illustrating a document M. FIGS. 12A to 12C are schematic diagrams each illustrating a read image P subjected to image processing. In FIG. 12B, d1 indicates a length of an overlapping part R along the X axis.

As illustrated in FIG. 11A, a first line image L1 and a second line image L2 are formed on the document M. Specifically, the document M has an image formed thereon in which the first line image L1 and the second line image L2 illustrated in FIG. 11B overlap each other. The first line image L1 has the shape of a straight line extending along the X axis. The second line image L2 has the shape of a hollow rectangle. Since the second line image L2 overlaps the first line image L1, part of the first line image L1 cannot be seen as illustrated in FIG. 11A. That is, the first line image L1 formed on the document M is interrupted. Therefore, it cannot be confirmed by seeing the document M whether or not the first line image L1 is continuous though it can be confirmed that the second line image L2 is continuous.

In a situation in which the first line image L1 is interrupted as illustrated in FIG. 11A, the image processing device 100 performs image processing to maintain continuity of the first line image L1.

The image reading section 10 acquires the read image P as illustrated in FIG. 12A by reading the image from the document M. The line image detection section 22 then detects a plurality of line images included in the read image P. In the present embodiment, the line image detection section 22 detects a first line image LP1 and a second line image LP2 included in the read image P. The first line image LP1 corresponds to the first line image L1 formed on the document M. The second line image LP2 corresponds to the second line image L2 formed on the document M. The first line image LP1 and the second line image LP2 each have a constant width.

The first line image LP1 is a line image of a first line type. The second line image LP2 is a line image of a second line type. The first line type and the second line type differ from each other. The first line type indicates dash line, for example. The second line type indicates solid line, for example.

The overlapping part detection section 24 detects an overlapping part R as illustrated in FIG. 12B. The overlapping part detection section 24 detects, as the overlapping part R, an image region located between two line image segments of the same line type, for example. In the present embodiment, the overlapping part detection section 24 detects, as the overlapping part R, an image region located between a left line image segment and a right line image segment of the first line image LP1. The first line image LP1 and the second line image LP2 are parallel to each other in the overlapping part R.

The image processing section 26 divides the overlapping part R into a first region R1 and a second region R2. In the present embodiment, the image processing section 26 sets an upper half region of the overlapping part R as the first region R1 and sets a lower half region of the overlapping part R as the second region R2. The first region R1 and the second region R2 are equal in size in the present embodiment. Note that the first region R1 and the second region R2 may differ from each other in size.

The image processing section 26 performs image processing by setting the line type of the first region R1 to the first line type and setting the line type of the second region R2 to the second line type as illustrated in FIG. 12C. In the present embodiment, the image processing section 26 sets the line type of the upper half region (R1) of the overlapping part R to dash line in the image processing. Also, the image processing section 26 sets the line type of the lower half region (R2) of the overlapping part R to solid line in the image processing. In this configuration, continuity of each of the first line image LP1 and the second line image LP2 can be visually recognized. Therefore, it is possible to prevent the line images from losing continuity in the part where the line images overlap each other.

In the image processing method described with reference to FIGS. 1 and 11A to 12C, the image processing device 100 according to the present embodiment performs processing similar to that performed in the image processing method illustrated by the flowchart of FIG. 4 in all aspects other than Step S108. In the image processing method described with reference to FIGS. 1 and 11A to 12C, the image processing device 100 according to the present embodiment performs “dividing the overlapping part R into regions and setting different line types for the respective regions” instead of Step S108 in the flowchart of FIG. 4. Specifically, the image processing section 26 divides the overlapping part R into the first region R1 and the second region R2. The image processing section 26 then performs image processing by setting the line type of the first region R1 to the first line type and setting the line type of the second region R2 to the second line type.

As described above with reference to FIGS. 1 and 11A to 12C, the image processing section 26 of the image processing device 100 performs the image processing on the overlapping part R where the line images overlap each other. Therefore, it is possible to prevent the line images from losing continuity in the part where the line images overlap each other.

Also, the image processing section 26 divides the overlapping part R into the first region R1 and the second region R2. The image processing section 26 then performs the image processing by setting the line type of the first region R1 to the first line type and setting the line type of the second region R2 to the second line type. Thus, the respective regions of the part where the line images overlap are distinguished from each other in line type. In this configuration, it is possible to prevent the line images from losing continuity in the part where the line images overlap each other.

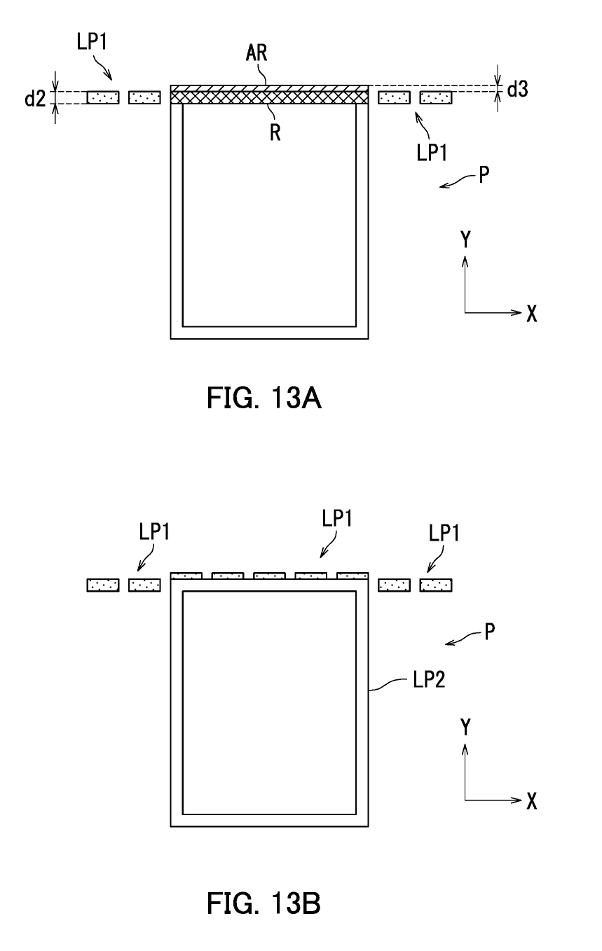

The following describes another image processing method performed by the image processing device 100 according to the embodiment of the present disclosure with reference to FIGS. 1, 11A, 11B, 13A, and 13B. FIGS. 13A and 13B are schematic diagrams each illustrating a read image P subjected to image processing. In FIG. 13A, d2 indicates a width of the overlapping part R (a length thereof along the Y axis). Also, d3 indicates a width of an adjacent region AR (a length thereof along the Y axis). The following image processing method differs from that described with reference to FIGS. 1 and 11A to 12C in contents of the image processing performed on the overlapping part R. Overlapping description of matter similar to that in the image processing method described with reference to FIGS. 1 and 11A to 12C will be omitted.

As illustrated in FIG. 13A, the image processing section 26 defines the adjacent region AR adjacent to the overlapping part R. The adjacent region AR extends along the overlapping part R.

As illustrated in FIG. 13B, the image processing section 26 performs the image processing by setting the line type of the overlapping part R to one of the first line type and the second line type and setting the line type of the adjacent region AR to the other of the first line type and the second line type. In the present embodiment, the image processing section 26 sets the line type of the overlapping part R to solid line. Also, the image processing section 26 sets the line type of the adjacent region AR to dash line. In this configuration, continuity of each of the first line image LP1 and the second line image LP2 can be visually recognized. Therefore, it is possible to prevent the line images from losing continuity in the part where the line images overlap each other.

In the image processing method described with reference to FIGS. 1, 11A, 11B, 13A, and 13B, the image processing device 100 according to the present embodiment performs processing similar to that performed in the image processing method illustrated by the flowchart of FIG. 6 in all aspects other than Step S208. In the image processing method described with reference to FIGS. 1, 11A, 11B, 13A, and 13B, the image processing section 26 of the image processing device 100 according to the present embodiment performs image processing by “setting the line type of the overlapping part R to one of the first line type and the second line type and setting the line type of the adjacent region AR to the other of the first line type and the second line type” instead of Step S208 in FIG. 6.

As described above with reference to FIGS. 1, 11A, 11B, 13A, and 13B, the image processing is performed by setting the line type of the overlapping part R to one of the first line type and the second line type and setting the line type of the adjacent region AR to the other of the first line type and the second line type. In this configuration, continuity of each of the first line image LP1 and the second line image LP2 can be visually recognized. Therefore, it is possible to prevent the line images from losing continuity in the part where the line images overlap each other.

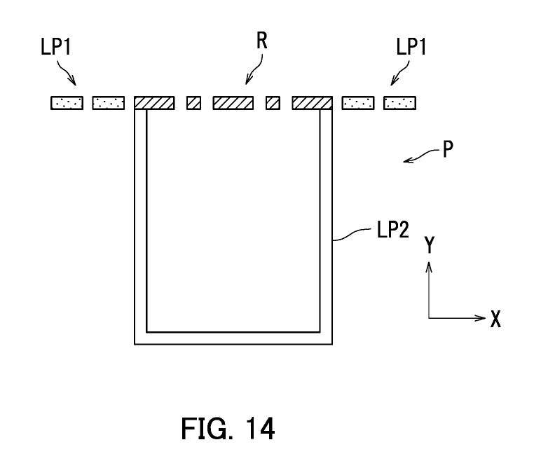

The following describes another image processing method performed by the image processing device 100 according to the embodiment of the present disclosure with reference to FIGS. 1, 11A, 11B, and 14. FIG. 14 is a schematic diagram illustrating a read image P subjected to image processing. The following image processing method differs from those described with reference to FIGS. 1 and 11A to 13B in contents of the image processing performed on the overlapping part R. Overlapping description of matter similar to that in the image processing methods described with reference to FIGS. 1 and 11A to 13B will be omitted.

In a situation in which there is an overlapping part R, the image processing section 26 performs the image processing by setting the line type of the overlapping part R to a third line type as illustrated in FIG. 14. The third line type differs from the first line type and the second line type. In the present embodiment, the first line type indicates dash line, the second line type indicates solid line, and the third line type indicates dash-dot line. In the image processing, the image processing section 26 sets the line type of the overlapping part R to the third line type, which is dash-dot line in the present embodiment.

In the image processing method described with reference to FIGS. 1, 11A, 11B, and 14, the image processing device 100 according to the present embodiment performs processing similar to that performed in the image processing method illustrated by the flowchart of FIG. 8 in all aspects other than Step S308. In the image processing method described with reference to FIGS. 1, 11A, 11B, and 14, the image processing section 26 of the image processing device 100 according to the present embodiment performs image processing by “setting the line type of the overlapping part R to the third line type” instead of Step S308 in FIG. 8.

As described above with reference to FIGS. 1, 11A, 11B, and 14, the image processing section 26 performs the image processing by setting the line type of the overlapping part R to the third line type. In this configuration, it is possible to visually recognize that the first line image LP1 and the second line image LP2 overlap each other in the overlapping part R. Therefore, it is possible to prevent the line images from losing continuity in the part where the line images overlap each other.

Note that similarly to the image processing method described with reference to FIG. 9, the image processing section 26 may change contents of image processing according to the length d1 of the overlapping part R. For example, “dividing the overlapping part R into regions, and setting different line types for the respective regions” may be performed instead of Step S410 in FIG. 9. Further, the image processing section 26 may perform the image processing by “setting the line type of the overlapping part R to one of the first line type and the second line type and setting the line type of the adjacent region AR to the other of the first line type and the second line type” instead of Step S412 in FIG. 9.

Through the above, an embodiment of the present disclosure has been described with reference to the accompanying drawings (FIGS. 1 to 14). However, the present disclosure is not limited to the above embodiment, and can be practiced in various forms within a scope not departing from the gist of the present disclosure. The drawings schematically illustrate elements of configuration to facilitate understanding. Properties such as thickness and length, and the number of each element of configuration illustrated in the drawings may differ from actual ones thereof to facilitate preparation of the drawings. Also, material, shape, dimensions, and the like of each element of configuration described in the above embodiment are merely examples and should not be taken to limit the present disclosure. Various alterations can be made within a scope not substantially departing from the effects of the present disclosure.

Although the image processing section 26 performs image processing on the overlapping part R where two line images overlap each other as described with reference to FIGS. 1 to 14, the present disclosure is not limited to this configuration. For example, the image processing section 26 may perform image processing on an overlapping part R where three or more line images overlap each other.

What is claimed is:

1. An image processing device comprising:
an image reading section configured to acquire a read image by reading an image from a document;
a line image detection section configured to detect a plurality of line images included in the read image, the plurality of line images including a first line image and a second line image;
an overlapping part detection section configured to detect an overlapping part where the first line image and the second line image overlap each other; and
an image processing section configured to perform image processing on the overlapping part.

2. The image processing device according to claim 1, wherein
the first line image has a first color,
the second line image has a second color differing from the first color,
the image processing section divides the overlapping part into a first region and a second region, and
the image processing section performs the image processing by setting a color of the first region to the first color and setting a color of the second region to the second color.

3. The image processing device according to claim 2, wherein
the first region and the second region are equal in size.

4. The image processing device according to claim 2, wherein
the first region and the second region differ from each other in size.

5. The image processing device according to claim 1, wherein
the first line image has a first color,
the second line image has a second color differing from the first color,
the image processing section defines an adjacent region that is adjacent to the overlapping part and that extends along the overlapping part, and
the image processing section performs the image processing by setting a color of the overlapping part to one of the first color and the second color and setting a color of the adjacent region to the other of the first color and the second color.

6. The image processing device according to claim 5, wherein
the image processing section determines a size of the adjacent region on the basis of a difference in hue between the first color and the second color.

7. The image processing device according to claim 6, wherein
the image processing section determines the size of the adjacent region in such a manner that the smaller the difference is, the larger the adjacent region becomes, and the larger the difference is, the smaller the adjacent region becomes.

8. The image processing device according to claim 1, wherein
the first line image has a first color,
the second line image has a second color differing from the first color,
the image processing section performs the image processing by setting a color of the overlapping part to a third color differing from the first color and the second color.

9. The image processing device according to claim 8, wherein
the third color is a mixed color of the first color and the second color.

10. The image processing device according to claim 1, wherein
the first line image is a line image of a first line type,
the second line image is a line image of a second line type differing from the first line type,
the image processing section divides the overlapping part into a first region and a second region, and
the image processing section performs the image processing by setting a line type of the first region to the first line type and setting a line type of the second region to the second line type.

11. The image processing device according to claim 1, wherein
the first line image is a line image of a first line type,
the second line image is a line image of a second line type differing from the first line type,
the image processing section defines an adjacent region that is adjacent to the overlapping part and that extends along the overlapping part, and
the image processing section performs the image processing by setting a line type of the overlapping part to one of the first line type and the second line type and setting a line type of the adjacent region to the other of the first line type and the second line type.

12. The image processing device according to claim 1, wherein
the first line image is a line image of a first line type,
the second line image is a line image of a second line type differing from the first line type,
the image processing section performs the image processing by setting a line type of the overlapping part to a third line type differing from the first line type and the second line type.

13. The image processing device according to claim 1, wherein
the image processing section changes contents of the image processing according to a length of the overlapping part.

14. The image processing device according to claim 1, wherein
the overlapping part detection section detects, as the overlapping part, an image region located between two line image segments of the same color or an image region located between two line image segments of the same line type.

15. The image processing device according to claim 1, wherein
the first line image and the second line image are parallel to each other in the overlapping part.

16. The image processing device according to claim 1, wherein
the first line image and the second line image each have a constant width.
